(19) United States
(12) Patent Application Publication
(10) Pub. No.: US 2009/0258674 A1
(43) Pub. Date: Oct. 15, 2009

(54) SYSTEM AND METHOD FOR AUTOMATICALLY UPDATING PRESENCE INFORMATION

(75) Inventor: Henrik Groth, Solna (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/100,803

(22) Filed: Apr. 10, 2008

(51) Int. Cl. H04M 1/00; H04Q 7/20; G06F 15/00; G08B 21/00

(52) U.S. Cl. 455/556.1; 455/456.1; 340/540; 340/669; 702/141

(57) ABSTRACT

A system, method and computer program that utilizes motion detection circuitry, calendar information and/or time information to automatically update presence information associated with portable electronic equipment. Aspects of the present invention provide reliable presence information regarding the availability of the user based on motion of the electronic equipment (also referred to herein as electronic device) and user's calendar information and optionally time information. The availability of reliable presence information will significantly increase the usage of presence information.

### TECHNICAL FIELD OF THE INVENTION

The present invention relates generally to portable electronic equipment and, more particularly, to a portable electronic device that has utilizes motion detection circuitry, calendar information and/or time information to automatically update presence information associated with the portable electronic equipment.

### DESCRIPTION OF THE RELATED ART

Mobile and/or wireless electronic devices are becoming increasingly popular. For example, mobile telephones, portable media players and portable gaming devices are now in wide-spread use. In addition, the features associated with certain types of electronic devices have become increasingly diverse. To name a few examples, many electronic devices have cameras, text messaging capability, Internet browsing capability, electronic mail capability, video playback capability, audio playback capability, image display capability and handsfree headset interfaces. With all of these features, such devices are generally available to the user at all times of the day (e.g., day and night) and on all occasions (e.g., business and personal use).

### SUMMARY

A system, method and computer program that utilizes motion detection circuitry, calendar information and/or time information to automatically update presence information associated with the portable electronic equipment. Aspects of the present invention provide reliable presence information regarding the availability of the user based on motion of the electronic equipment (also referred to herein as electronic device) and user's calendar information and optionally time information. The availability of reliable presence information will significantly increase the usage of presence information.

One aspect of the invention relates to an electronic device including: a memory for storing calendar information and time information; motion detection circuitry configured to detect motion of the electronic device and generate an output signal corresponding to a detected motion of the electronic equipment; and a processor coupled to the motion detection circuitry and the memory, wherein the processor processes the output signal of the motion detection circuitry, the calendar information and the time information to determine a presence value associated with the electronic device for output to an associated network.

Another aspect of the invention relates to the motion detection circuitry including an accelerometer.

Another aspect of the invention relates to the motion detection circuitry including circuitry for measuring relative speed of the electronic equipment.

Another aspect of the invention relates to a presence profile stored in the memory, wherein the presence profile determines a presence value for the electronic device based upon the calendar information and the output signal of the motion detection circuitry.

Another aspect of the invention relates to radio circuitry coupled to the processor, wherein the radio circuitry may output the presence value to the associated network.

Another aspect of the invention relates to the presence value including information associated with the calendar information.

Another aspect of the invention relates to the presence value including information associated with the time information.

Another aspect of the invention relates to the presence value including a user defined message based on the output signal corresponding to a detected motion of the electronic device and at least one of the calendar information and the time information.

Another aspect of the invention relates to the electronic device being a portable communication device.

One aspect of the present invention relates to a method for updating presence information for an electronic equipment, the method including: detecting motion associated with an electronic device by motion detection circuitry housed within the electronic equipment, wherein the motion detection circuitry outputs an output signal corresponding to a detected motion of the electronic device; processing calendar information and time information upon detecting motion associated with the electronic device in a predefined manner to determine a presence value associated with the electronic equipment; and outputting the presence value to an associated network.

Another aspect of the invention relates to the step of detecting motion including detecting acceleration of the electronic equipment.

Another aspect of the invention relates to the step of detecting motion including detecting velocity of the electronic equipment.

Another aspect of the invention relates to the predefined manner including comparing the calendar information and the time information with a presence profile to determine a presence value for the electronic equipment.

Another aspect of the invention relates to the presence value varying as a function of calendar information.

Another aspect of the invention relates to the presence value varying as a function of time information.

Another aspect of the invention relates to the presence value varying as a function of detected motion.

Another aspect of the invention relates to the presence value being updated at predefined times.

Another aspect of the invention relates to the presence value being updated when the presence value changes from a first state to a second state.

One aspect of the invention relates to a computer program stored on a machine readable medium in an electronic device, the program being suitable for processing information received from motion detection circuitry, calendar information and time information to determine a presence value associated with the electronic device and outputting the presence value to an associated presence server, wherein the presence value is indicative of a motion detected by the motion detection circuitry and calendar information.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the scope of the claims appended hereto.

Features that are described and/or illustrated with respect to one embodiment may be used in the same way or in a similar way in one or more other embodiments and/or in combination with or instead of the features of the other embodiments.

It should be emphasized that the terms “comprises” and “comprising,” when used in this specification, are taken to specify the presence of stated features, integers, steps or components but do not preclude the presence or addition of one or more other features, integers, steps, components or groups thereof.

### BRIEF DESCRIPTION OF THE DRAWINGS

FIG. 1 is a schematic view of one embodiment of a mobile telephone as an exemplary electronic device in accordance with the present invention;

FIG. 2 is a schematic block diagram of the relevant portions of the mobile telephone of FIG. 1;

FIG. 3 is a schematic diagram of a communications system in which the mobile telephone of FIG. 1 may operate; and

FIG. 4 is a flow chart representing an exemplary method of controlling user preferences of an electronic device.

### DETAILED DESCRIPTION OF EMBODIMENTS

Embodiments of the present invention will now be described with reference to the drawings, wherein like reference numerals are used to refer to like elements throughout. It will be understood that the figures are not necessarily to scale.

The interchangeable terms “electronic equipment” and “electronic device” include portable radio communication equipment. The term “portable radio communication equipment,” which hereinafter is referred to as a “mobile radio terminal,” includes all equipment such as mobile telephones, pagers, communicators, electronic organizers, personal digital assistants (PDAs), smartphones, portable communication apparatus or the like.

In the present application, embodiments of the invention are described primarily in the context of a mobile telephone. However, it will be appreciated that the invention is not intended to be limited to the context of a mobile telephone and may relate to any type of appropriate electronic equipment, examples of which include a media player, a gaming device and a computer.

Presence information is increasing in importance due to the expanding use of modern communications such as mobile phones, e-mail, instant messaging (IM) (e.g., chat sessions), etc. One benefit of having reliable presence information available to other users is the user that wants to initiate communication with someone can get a better understanding of whether the receiving user or users are available for communication. The user that initiates communication can determine the appropriate time to contact a user based upon the presence information.

Conventionally, presence information has been used in instant messaging (e.g., chat applications) to see if the receiving user is at his desktop (e.g., “available”) or not (e.g., “away”). One problem with conventional presence values is that they are not updated automatically, which substantially limits the usefulness of such information. Generally, presence information is manually entered by the user. For example, a user would be required to set the presence value to “away” before leaving the desktop computer. Some conventional application provide rudimentary functionality to automatically set a presence value. For example the “away status” on a desktop computer can be set when the user has not interacted with the computer for a predefined period of time (e.g., five minutes) or when the screen saver is active. This leads to a much heavier usage of the away presence status than if every user should have need to manually set the presence to away before leaving the computer. Another disadvantage is that conventional presence information is not based on motion of the electronic device, a user's calendar information and/or time information.

In order to make presence information increasingly useful, aspects of this invention relate to an electronic equipment, method and computer program for automatically combining user movement, as detected by motion detection circuitry with the electronic device, with calendar information and optionally time information in a predefined manner to determine a presence value associated with the electronic equipment. As a result of automatic presence value determination being based on motion and calendar information (and optionally time information), presence values provide a reliable indicator to the availability of users. Accordingly, there will be a substantial increase in the usage of presence information.

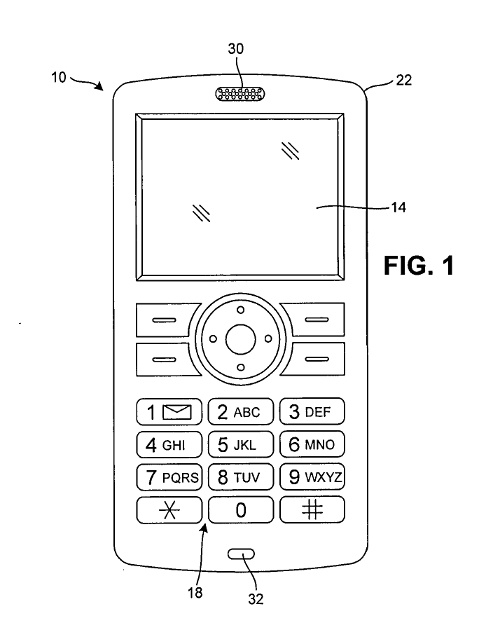

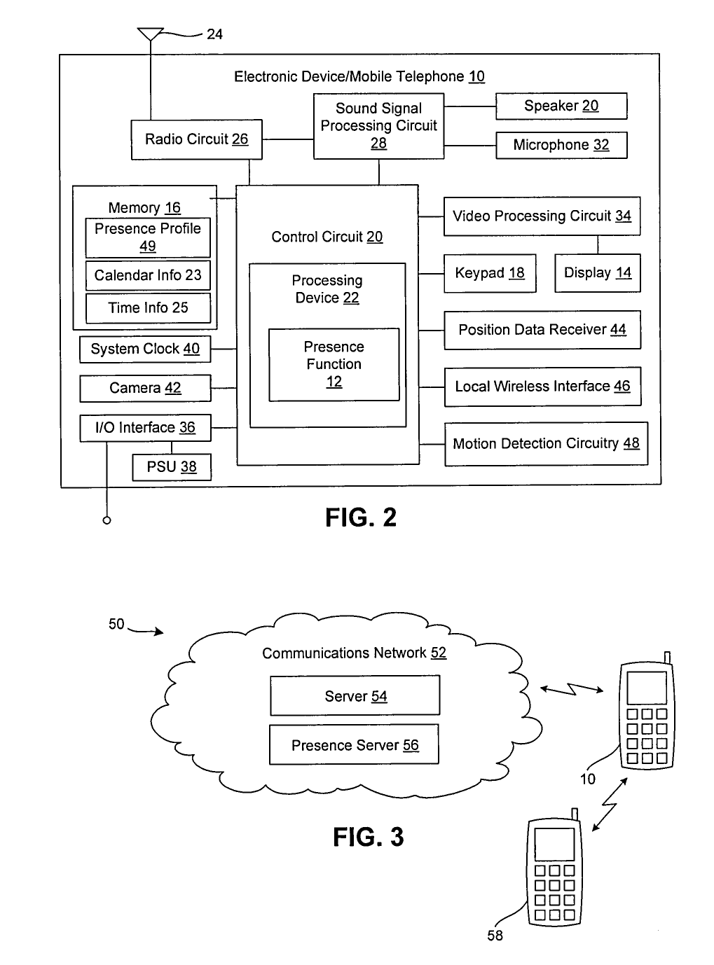

Referring initially to FIGS. 1 and 2, an exemplary portable electronic device 10 is shown. The electronic device 10 is configured with motion detection circuitry that generates an output signal corresponding to motion of the electronic device. The electronic device 10 further includes calendar information and optionally time information. The electronic device 10 processes the output signal of the motion detection circuitry with the calendar information and optionally the time information to determine a presence value for the electronic device. The presence value for the electronic device is output to a presence server so that individuals interested in contacting the user of the electronic device may view the presence information to determine if it is appropriate to contact the user.

The electronic device 10 may include a presence function 12 that is configured to determine the presence value of the electronic device. Additional details and operation of the presence function 12 will be described in greater detail below. The presence function 12 may be embodied as executable code that is resident in and executed by the electronic device 10. In one embodiment, the presence function 12 may be a program stored on a computer or machine readable medium. The presence function 12 may be a stand-alone software application or form a part of a software application that carries out additional tasks related to the electronic device 10. The presence function 12 may be stored in memory 16 and/or in firmware, as discussed below.

The electronic device of the illustrated embodiment is a mobile telephone and will be referred to as the mobile telephone 10. The mobile telephone 10 is shown as having a “brick” or “block” form factor housing, but it will be appreciated that other housing types may be utilized, such as a “flip-open” form factor (e.g., a “clamshell” housing) or a slide-type form factor (e.g., a “slider” housing).

The mobile telephone 10 may include a display 14. The display 14 displays information to a user such as operating state, time, telephone numbers, contact information, various navigational menus, etc., through a graphical user interface (GUI) that enables the user to utilize the various features of the mobile telephone 10. The display 14 also may be used to visually display content received by the mobile telephone 10 and/or retrieved from a memory 16 (FIG. 2) of the mobile telephone 10. The display 14 may be used to present images, video and other graphics to the user, such as photographs, mobile television content and video associated with games.

A keypad 18 provides for a variety of user input operations. For example, the keypad 18 typically includes alphanumeric keys for allowing entry of alphanumeric information such as telephone numbers, phone lists, contact information, notes, etc. In addition, the keypad 18 typically includes special function keys such as a “call send” key for initiating or answering a call, and a “call end” key for ending or “hanging up” a call. Special function keys also may include menu navigation and select keys to facilitate navigating through a menu displayed on the display 14. For instance, a pointing device and/or navigation keys may be present to accept directional inputs from a user. Special function keys may include audiovisual content playback keys to start, stop and pause playback, skip or repeat tracks, and so forth. Other keys associated with the mobile telephone may include a volume key, an audio mute key, an on/off power key, a web browser launch key, a camera key, etc. Keys or key-like functionality also may be embodied as a touch screen associated with the display 14. Also, the display 14 and keypad 18 may be used in conjunction with one another to implement soft key functionality.

The mobile telephone 10 includes call circuitry that enables the mobile telephone 10 to establish a call and/or exchange signals with a called/calling device, typically another mobile telephone or landline telephone. However, the called/calling device need not be another telephone, but may be some other device such as an Internet web server, content providing server, etc. Calls may take any suitable form. For example, the call could be a conventional call that is established over a cellular circuit-switched network or a voice over Internet Protocol (VoIP) call that is established over a packet-switched capability of a cellular network or over an alternative packet-switched network, such as WiFi (e.g., a network based on the IEEE 802.11 standard), WiMax (e.g., a network based on the IEEE 802.16 standard), etc. Another example includes a video enabled call that is established over a cellular or alternative network.

The mobile telephone 10 may be configured to transmit, receive and/or process data, such as text messages (e.g., a text message is commonly referred to by some as “an SMS,” which stands for simple message service), instant messages, electronic mail messages, multimedia messages (e.g., a multimedia message is commonly referred to by some as “an MMS,” which stands for multimedia message service), image files, video files, audio files, ring tones, streaming audio, streaming video, data feeds (including podcasts) and so forth. Processing such data may include storing the data in the memory 16, executing applications to allow user interaction with data, displaying video and/or image content associated with the data, outputting audio sounds associated with the data and so forth.

FIG. 2 represents a functional block diagram of the mobile telephone 10. For the sake of brevity, generally conventional features of the mobile telephone 10 will not be described in great detail herein. The mobile telephone 10 includes a primary control circuit 20 that is configured to carry out overall control of the functions and operations of the mobile telephone 10. The control circuit 20 may include a processing device 22, such as a CPU, microcontroller or microprocessor. The processing device 22 executes code stored in a memory (not shown) within the control circuit 20 and/or in a separate memory, such as the memory 16, in order to carry out operation of the mobile telephone 10. The memory 16 may be, for example, one or more of a buffer, a flash memory, a hard drive, a removable media, a volatile memory, a non-volatile memory, a random access memory (RAM), or other suitable device.

The memory 16 generally includes calendar information 23. Calendar information may include any information related to a calendar application. Such information may include, for example, appointments, description of appointments, location of appointments, contact information associated with appointment, time of appointment, duration of appointment, tasks, etc. The calendar information 23 may also be stored remotely, for example, on an external server. The calendar information 23 may be provided from any suitable calendar application (e.g., Microsoft Outlook, Google Calendar, GroupWise Calendar, Yahoo Calendar, etc.). The memory 16 may optionally include time information 25. The time information may include any type of time related information. Such information may include, for example, time of day, time till next appointment, time in current communication state, expected duration of appointment, etc. While shown as separate information entities, one of ordinary skill in the art will readily appreciate that time information and calendar information may be stored jointly in a single data structure.

The processing device 22 may execute code that implements the presence function 12. It will be apparent to a person having ordinary skill in the art of computer programming, and specifically in application programming for mobile telephones or other electronic devices, how to program a mobile telephone 10 to operate and carry out logical functions associated with the presence function 12. Accordingly, details as to specific programming code have been left out for the sake of brevity. Also, while the presence function 12 is executed by the processing device 22 in accordance with a preferred embodiment of the invention, such functionality could also be carried out via dedicated hardware, firmware, software, or combinations thereof, without departing from the scope of the invention.

Continuing to refer to FIGS. 1 and 2, the mobile telephone 10 includes an antenna 24 coupled to a radio circuit 26. The radio circuit 26 includes a radio frequency transmitter and receiver for transmitting and receiving signals via the antenna 24 as is conventional. The radio circuit 26 may be configured to operate in a mobile communications system and may be used to send and receive data and/or audiovisual content. Receiver types for interaction with a mobile radio network and/or broadcasting network include, but are not limited to, GSM, CDMA, WCDMA, GPRS, WiFi, WiMax, DVB-H, ISDB-T, etc., as well as advanced versions of these standards.

The mobile telephone 10 further includes a sound signal processing circuit 28 for processing audio signals transmitted by and received from the radio circuit 26. Coupled to the sound processing circuit 28 are a speaker 30 and a microphone 32 that enable a user to listen and speak via the mobile telephone 10 as is conventional. The radio circuit 26 and sound processing circuit 28 are each coupled to the control circuit 20 so as to carry out overall operation. Audio data may be passed from the control circuit 20 to the sound signal processing circuit 28 for playback to the user. The audio data may include, for example, audio data from an audio file stored by the memory 16 and retrieved by the control circuit 20, or received audio data such as in the form of streaming audio data from a mobile radio service. The sound processing circuit 28 may include any appropriate buffers, decoders, amplifiers and so forth.

The display 14 may be coupled to the control circuit 20 by a video processing circuit 34 that converts video data to a video signal used to drive the display 14. The video processing circuit 34 may include any appropriate buffers, decoders, video data processors and so forth. The video data may be generated by the control circuit 20, retrieved from a video file that is stored in the memory 16, derived from an incoming video data stream that is received by the radio circuit 28 or obtained by any other suitable method.

The mobile telephone 10 may further include one or more I/O interface(s) 36. The I/O interface(s) 36 may be in the form of typical mobile telephone I/O interfaces and may include one or more electrical connectors. As is typical, the I/O interface(s) 36 may be used to couple the mobile telephone 10 to a battery charger to charge a battery of a power supply unit (PSU) 38 within the mobile telephone 10. In addition, or in the alternative, the I/O interface(s) 36 may serve to connect the mobile telephone 10 to a headset assembly (e.g., a personal handsfree (PHF) device) that has a wired interface with the mobile telephone 10. Further, the I/O interface(s) 36 may serve to connect the mobile telephone 10 to a personal computer or other device via a data cable for the exchange of data. The mobile telephone 10 may receive operating power via the I/O interface(s) 36 when connected to a vehicle power adapter or an electricity outlet power adapter.

The mobile telephone 10 also may include a system clock 40 for clocking the various components of the mobile telephone 10, such as the control circuit 20. The control circuit 20 may, in turn, carry out timing functions, such as timing the durations of calls, generating the content of time and date stamps, and so forth.

The mobile telephone 10 may include a camera 42 for taking digital pictures and/or movies. Image and/or video files corresponding to the pictures and/or movies may be stored in the memory 16.

The mobile telephone 10 also may include a position data receiver 44, such as a global positioning system (GPS) receiver, Galileo satellite system receiver or the like. The position data receiver 44 may be involved in ascertaining the location of the mobile telephone 10. The determination of the location of the mobile telephone 10 will be described in greater detail below.

The mobile telephone 10 also may include a local wireless interface 46, such as an infrared transceiver and/or an RF interface (e.g., a Bluetooth interface), for establishing communication with an accessory, another mobile radio terminal, a computer or another device. For example, the local wireless interface 46 may operatively couple the mobile telephone 10 to a headset assembly (e.g., a PHF device) in an embodiment where the headset assembly has a corresponding wireless interface.

The mobile telephone 10 also may include motion detection circuitry 48. The motion detection circuitry may be any type of circuitry that is capable of detecting relative motion of the mobile telephone 10. The motion detection circuitry 48 may be a contact-less sensor, a single sensor, a plurality of sensors and/or an array of sensors. The phrase “motion detection circuitry” is intended to be interpreted broadly to include any type of sensor, any number of sensors and/or any arrangement of sensors that is capable of detecting motion (also referred to herein as movement) of the mobile telephone 10. Exemplary sensors include accelerometers, speedometers, velocitometers, infrared sensors (e.g., phototransistors and photodiodes), ultrasonic sensors, electromagnetic sensors, thermal sensors (e.g., heat sensors), location and/or position sensors, etc. The motion detection circuitry 48 may be located in any desirable position on the electronic device 10. The location of the motion detection circuitry 48 may vary based on a number of design considerations. Such design considerations include, for example, the type of sensors used, the number of sensors, the size and shape of the electronic equipment, etc. For example, the motion detection circuitry 48 in the form of an accelerometer may be housed internally of the mobile telephone 10, while other sensors, e.g., velocity sensor, may be located partially internally, partially externally and/or wholly externally.

With additional reference to FIG. 3, the mobile telephone 10 may be configured to operate as part of a communications system 50. The system 50 may include a communications network 52 having a server 54 (or servers) for managing calls placed by and destined to the mobile telephone 10, transmitting data to the mobile telephone 10 and carrying out any other support functions. The communications network 52 may also include a presence server 56. The presence server 56 is operable to provide information usable by electronic devices (e.g., electronic devices 10, 58) that are coupled to the communication network 50 to determine presence values associated with users on the network. As used herein, the term “presence server” includes any applicable application server capable of providing presence information (e.g., at least location information for portable communication devices), as discussed below. For purposes of this discussion, the term “presence server” may be replaced with location server without departing from the scope of the present invention. In addition, the presence server may be combined with one or more other servers to provide the functionality described herein. For example, the server 54 may also function as a presence server even though it also supports one or more other call functions.

The server 54 and presence server 56 communicate with the mobile telephone 10 via a transmission medium. The transmission medium may be any appropriate device or assembly, including, for example, a communications tower (e.g., a cell tower), another mobile telephone, a wireless access point, a satellite, etc. Portions of the network may include wireless transmission pathways. The network 52 may support the communications activity of multiple mobile telephones 10, 58 and other types of end user devices. As will be appreciated, the servers 54, 56 may be configured as a typical computer system used to carry out server functions and may include a processor configured to execute software containing logical instructions that embody the functions of the servers 54, 56 and a memory to store such software.

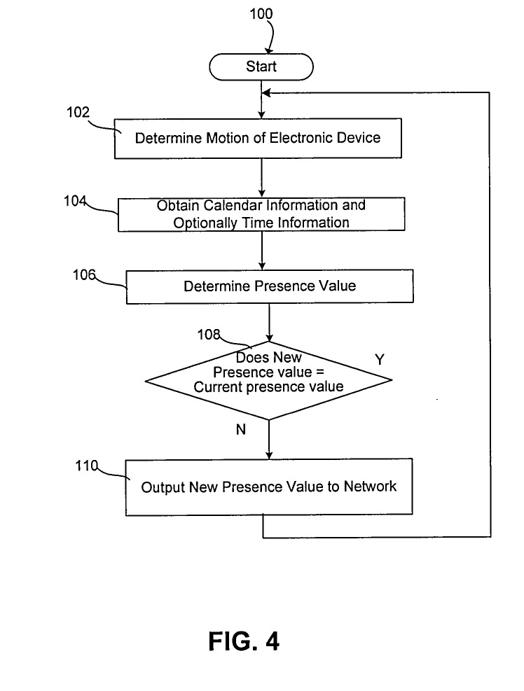

With additional reference to FIG. 4, illustrated are logical operations to implement an exemplary method 100 for updating presence information for an electronic device 10. At block 102, a determination is made as to whether the electronic device is in motion. Such a determination is may be made by the motion detection circuitry 48. The motion detection circuitry 48 generally outputs an output signal corresponding to a detected motion of the electronic equipment. As stated above, the motion detection circuitry 48 may be hardware, software, firmware and/or any combination of hardware, software or firmware. For example, the motion detection circuitry may be one or more sensors that calculate acceleration (e.g., an accelerometer, etc.) velocity (e.g., speedometer, velocitometer, etc.) and/or position (e.g., gyroscope) of the electronic device.

At block 104, calendar information and optionally time information is obtained. The calendar information and time information may be obtained from information stored in memory and/or available remotely (e.g., a remote calendar server). For example, the calendar information and time information may be associated with one or more calendar applications (e.g., Microsoft Outlook, Novell GroupWise, Google Calendar, etc.)

At block 106 a presence value associated with the electronic device 10 is determined. Generally, the presence value is determined by processing the output signal of the movement detection circuitry, calendar information and optionally time information to determine a presence value to be assigned to the electronic device. The presence function 12 generally processes the output signal from the motion detection circuitry 48 with the calendar information 23 and optionally time information 25 to determine a presence value for the electronic device 10. The determination of the presence value may be based on a presence profile 49, which is stored in memory. The memory profile 49 may have predetermined designations for presence values and/or user defined designations that may be output as presence values. The presence profile 49 may be in the form of a database, look-up-table (LUT), etc.

The presence profile 49 may include columns having one or more predetermined values for motion detection, calendar information and/or optionally time information. For example, the presence profile may include values that correspond to detecting no motion, detecting acceleration, detecting velocity, etc. The presence profile 49 may include values that correspond to various detected ranges. For example, a velocity above 3 miles per hour may be associated with walking, a velocity of 6 miles per hour may be associated with running, a velocity above 20 miles per hour may be associated with driving a vehicle, for example. Likewise there may be ranges for detected acceleration. In one embodiment, the presence profile 49 processes in a predefined manner and/or user defined manner to determine status. For example, the motion detection information, calendar information and optionally time information may be compared with a predetermined data stored in the presence profile to determine an appropriate presence value for the electronic equipment.

The presence profile 49 may obtain information directly from the calendar information 23 and/or time information 25 at any desired time. For example, the calendar information 23 and time information 25 may be populated directly into the presence profile 49 when entered or otherwise acquired. In another embodiment, the calendar information 23 and the time information may be periodically obtained by the presence profile 49 for use in determining a presence value for the electronic device.

At block 108, at determination is made as to whether the new presence value is the same as the previous presence value. If the new presence value is equal to the previous presence value, processing returns to block 102. If the new presence value is not the same as the previous presence value, the new presence value is output to the presence server 54 so that it may be accessible to other electronic devices (e.g., electronic device 58) that have access to the network 52. Thus, the presence value may be updated when the presence value changes from a first state to a second state. After the presence value has been updated to the network, data flows returns to block 102 for automatically and continuously monitoring for motion associated with the electronic device, calendar information and time information.

Based on the above methodology, a typical use case is presented. User A is using MSN Messenger or another instant messenger application with his mobile phone and the user has enabled motion presence. When User A wakes up in the morning and puts the mobile telephone in his or her pocket, the mobile telephone is detecting that the time is 0653 and the mobile telephone is moving (i.e., motion associated with the mobile telephone is detected). The user's presence value may be set to “awake”. When the user is going to work the mobile telephone detects that the user is moving more or less constantly and the time is 0804 on a weekday, so the user's presence is set to “On the way to Work”. When the user arrives at the office, it is 0847 and the user puts his or her mobile telephone on their desk (no movement detected), the presence value is set to “Working” based on the time of day and the calendar information. At 0957 the phone detects movement and that Andy has accepted a meeting from 1000 to 1100, the presence value is set to “On the way to a meeting”.

Based on the above example, one of ordinary skill in the art can readily appreciate that the presence value may vary as a function of detected motion, a function of calendar information, a function of time information and/or a combination one or more these items. In addition, the presence value may be updated at predefined times. Preferably, the presence value includes information originating from the calendar information. For example, if the calendar information includes a lunch meeting from 1200-1300 at a particular restaurant. It may desirable for the presence value to indicate that the user is on the way to the restaurant and actually identify the restaurant by name, or identify the party by name. Of course, privacy concerns may be addressed by allowing particular electronic devices to see a generic message (e.g., “at lunch meeting” or “eating lunch”) and a user's trusted contacts may view the detailed message (e.g., “lunch meeting with Mark and Rob at The Eatery”).

The exemplary method may be carried out by executing an embodiment of the presence function 12, for example. Thus, the flow chart of FIG. 4 may be thought of as depicting steps of a method carried out by the electronic device 10. Although FIG. 4 shows a specific order of executing functional logic blocks, the order of executing the blocks may be changed relative to the order shown. Also, two or more blocks shown in succession may be executed concurrently or with partial concurrence. Certain blocks also may be omitted. In addition, any number of functions, logical operations, commands, state variables, semaphores or messages may be added to the logical flow for purposes of enhanced utility, accounting, performance, measurement, troubleshooting, and the like. It is understood that all such variations are within the scope of the present invention.

Although the invention has been shown and described with respect to certain preferred embodiments, it is understood that equivalents and modifications will occur to others skilled in the art upon the reading and understanding of the specification. The present invention includes all such equivalents and modifications, and is limited only by the scope of the following claims.

What is claimed is:

1. An electronic device comprising:
a memory for storing calendar information and time information;
motion detection circuitry configured to detect motion of the electronic device and generate an output signal corresponding to a detected motion of the electronic equipment; and
a processor coupled to the motion detection circuitry and the memory, wherein the processor processes the output signal of the motion detection circuitry, the calendar information and the time information to determine a presence value associated with the electronic device for output to an associated network.

2. The electronic device of claim 1, wherein the motion detection circuitry includes an accelerometer.

3. The electronic device of claim 1, wherein the motion detection circuitry includes circuitry for measuring relative speed of the electronic equipment.

4. The electronic device of claim 1 further including a presence profile stored in the memory, wherein the presence profile determines a presence value for the electronic device based upon the calendar information and the output signal of the motion detection circuitry.

5. The electronic device of claim 1 further including radio circuitry coupled to the processor, wherein the radio circuitry may output the presence value to the associated network.

6. The electronic device of claim 1, wherein the presence value includes information associated with the calendar information.

7. The electronic device of claim 1, wherein the presence value includes information associated with the time information.

8. The electronic device of claim 1, wherein the presence value includes a user defined message based on the output signal corresponding to a detected motion of the electronic device and at least one of the calendar information and the time information.

9. The electronic device of claim 1, wherein the electronic device is a portable communication device.

10. A method for updating presence information for an electronic equipment, the method comprising:
detecting motion associated with an electronic device by motion detection circuitry housed within the electronic equipment, wherein the motion detection circuitry outputs an output signal corresponding to a detected motion of the electronic device;
processing calendar information and time information upon detecting motion associated with the electronic device in a predefined manner to determine a presence value associated with the electronic equipment; and
outputting the presence value to an associated network.

11. The method of claim 10, wherein the step of detecting motion includes detecting acceleration of the electronic equipment.

12. The method of claim 10, wherein the step of detecting motion includes detecting velocity of the electronic equipment.

13. The method of claim 10, wherein the predefined manner includes comparing the calendar information and the time information with a presence profile to determine a presence value for the electronic equipment.

14. The method of claim 13, wherein the presence value varies as a function of calendar information.

15. The method of claim 13, wherein the presence value varies as a function of time information.

16. The method of claim 13, wherein the presence value varies as a function of detected motion.

17. The method of claim 10, wherein the presence value is updated at predefined times.

18. The method of claim 10, wherein the presence value is updated when the presence value changes from a first state to a second state.

19. A computer program stored on a machine readable medium in an electronic device, the program being suitable for processing information received from motion detection circuitry, calendar information and time information to determine a presence value associated with the electronic device and outputting the presence value to an associated presence server, wherein the presence value is indicative of a motion detected by the motion detection circuitry and calendar information.
